(19) United States
(12) Patent Application Publication
(10) Pub. No.: US 2018/0227546 A1
(43) Pub. Date: Aug. 9, 2018

(54) Electronic Mirror System

(71) Applicant: Marvin Johnson, Cambridge, MA (US)

(72) Inventor: Marvin Johnson, Cambridge, MA (US)

(21) Appl. No.: 15/728,998

(22) Filed: Oct. 10, 2017

Related U.S. Application Data
(60) Provisional application No. 62/454,136, filed on Feb. 3, 2017.

(51) Int. Cl. H04N 7/18; H04N 5/247; H04N 5/232; H04N 5/225

(52) U.S. Cl. CPC H04N 7/181; H04N 5/2252; H04N 5/23216; H04N 5/247

(57) ABSTRACT

An electronic mirror system. The system includes an electronic device including a housing having a front side, a rear side, and an interior volume that includes a first power supply and a first wireless transceiver. A display is disposed on the front side of the housing. A first camera including a frame with a first mounting fastener, a second power supply, and a second wireless transceiver is removably securable to the rear side of the housing. The electronic device is in operable communication with the first camera via the first wireless transceiver and the second wireless transceiver. The first camera is configured to continuously record images and transmit the continuously recorded images to the electronic device via the second wireless transceiver. The electronic device is configured to receive the continuously recorded images, and the display is configured to display the continuously recorded images.

### CROSS REFERENCE TO RELATED APPLICATIONS

This application claims the benefit of U.S. Provisional Application No. 62/454,136 filed on Feb. 3, 2017. The above identified patent application is herein incorporated by reference in its entirety to provide continuity of disclosure.

### BACKGROUND OF THE INVENTION

The present invention relates to electronic devices and cameras. More specifically, the present invention provides an electronic mirror system that utilizes a display and a removable camera for facilitating viewing of difficult to reach areas of a user's body.

Individuals often use mirrors to view parts of their body for various purposes. For example, it can be particularly useful to use a mirror to examine the skin for damaged areas or irregularities that may indicate the presence of skin cancer. However, it can be difficult to view the back side of the body using a single mirror. In order to view areas on their back, individuals sometimes face away from the mirror and use a handheld second mirror to reflect the image in the mirror, allowing them to see areas of the back reflected in the first mirror. However, a second handheld mirror is not always available, and even if a second handheld mirror is available, it can still be difficult to maneuver the second handheld mirror to see all desired areas. Individuals may be unable to detect possible cancerous areas, which can lead to serious medical issues if not quickly identified and treated. In view of the above, it is desirable to provide an electronic mirror system that includes an electronic device with a display screen and a removable camera. The camera can be removed and mounted behind the individual while the electronic device display screen is positioned in front of the individual, allowing them to view images of the rear of their body on the display screen.

### SUMMARY OF THE INVENTION

In view of the foregoing disadvantages inherent in the known types of mirror systems now present in the prior art, the present invention provides an electronic mirror system wherein the same can be utilized for providing convenience for the user when observing difficult to view areas of the body. In one embodiment of the present invention, the electronic mirror system includes an electronic device including a housing having a front side, a rear side, and an interior volume that includes a first power supply and a first wireless transceiver. A display is disposed on the front side of the housing. A first camera including a frame with a first mounting fastener, a second power supply, and a second wireless transceiver is removably securable to the rear side of the housing. The electronic device is in operable communication with the first camera via the first wireless transceiver and the second wireless transceiver. The first camera is configured to continuously record images and transmit the continuously recorded images to the electronic device via the second wireless transceiver. The electronic device is further configured to receive the continuously recorded images, and the display is configured to display the continuously recorded images.

An object of the present invention is to provide an electronic mirror system including a camera that can be mounted behind a user and a display that can be mounted in front of a user, enabling the user to easily view rear areas of the body.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective exploded view of the electronic mirror system.

FIG. 2 shows a perspective view of the electronic mirror system in use.

FIG. 3 shows a side view of the electronic mirror system in use.

FIG. 4 shows a diagram of the components of the electronic mirror system.

### DETAILED DESCRIPTION OF THE INVENTION

Reference is made herein to the attached drawings. Like reference numerals are used throughout the drawings to depict like or similar elements of the electronic mirror system. For the purposes of presenting a brief and clear description of the present invention, the preferred embodiment will be discussed as used for viewing areas of the body that are difficult to view using a traditional mirror. The figures are intended for representative purposes only and should not be considered to be limiting in any respect.

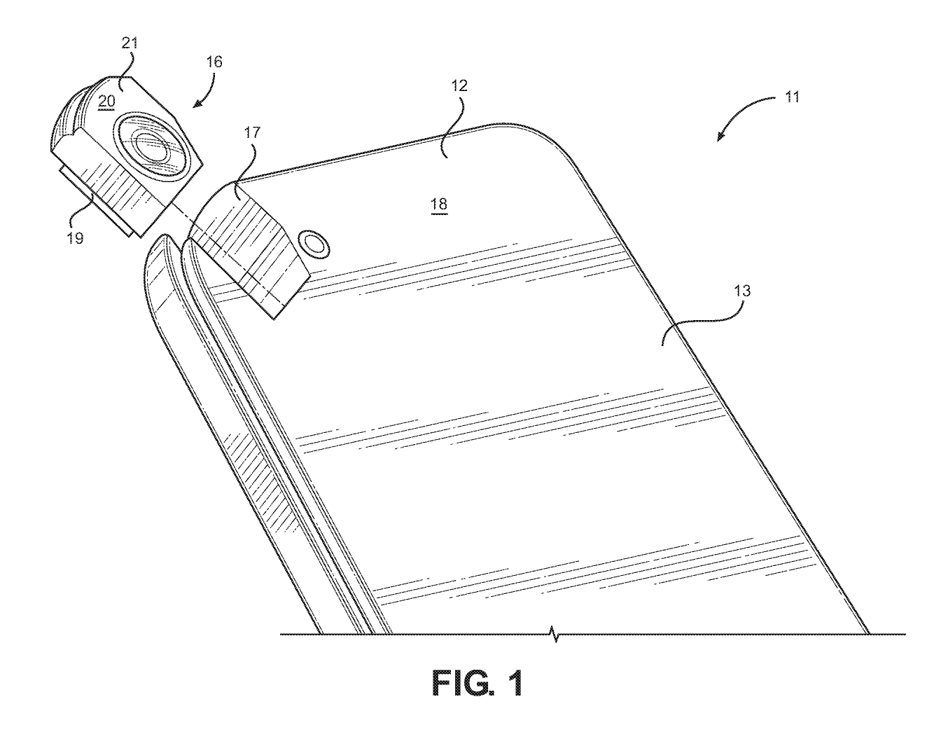

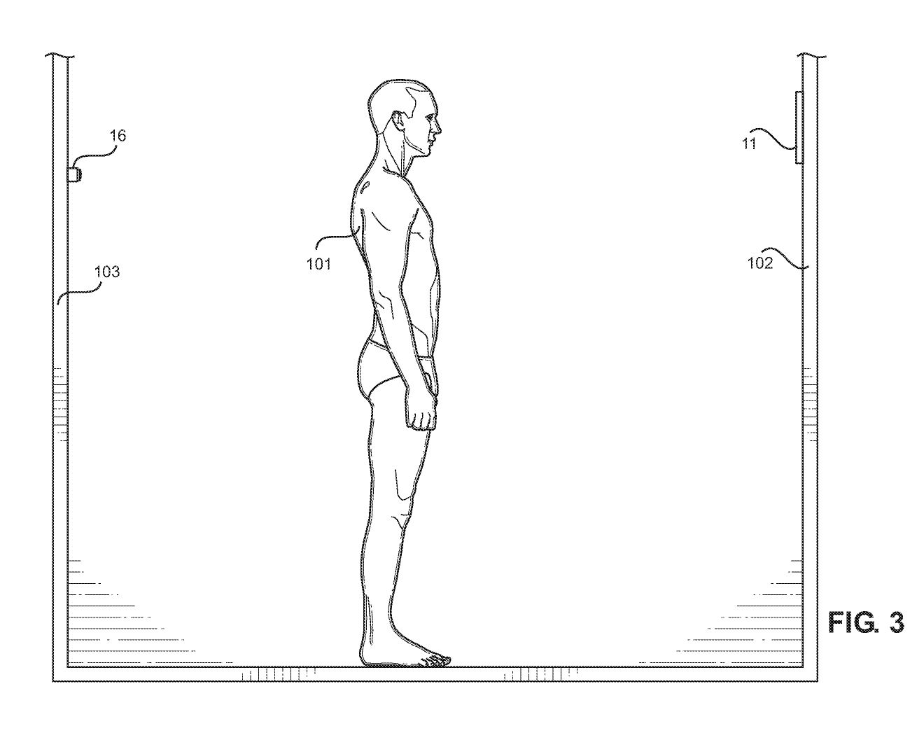

Referring now to FIG. 1, there is shown a perspective exploded view of the electronic mirror system. The electronic mirror system includes an electronic device 11, which is shown as a smartphone. The electronic device 11 can be any electronic device that includes at least one camera and at least one display screen, such as a laptop, computer tablet, smartphone, smartwatch, or the like. The electronic device 11 includes a first camera 16 removably securable thereto. The first camera 16 includes a first mounting fastener 19 on a rear side thereof for securing the first camera 16 to a wall 103 or another surface, and the electronic device 11 includes a second mounting fastener 28 on a rear side 13 thereof for securing the electronic device 11 to an opposing wall 102, as shown in FIG. 3, so that the user may utilize the display of the electronic device 11 as a mirror which displays images captured by the first camera 16. In one embodiment, the first and second mounting fasteners 19, 28 each include an adhesive material. In an alternative embodiment, the first and second mounting fasteners 19, 28 include additional fastening mechanisms, such as clips, hook and loop material, or the like.

The first camera 16 is removably securable to a slot 17 disposed in the housing 12 of the electronic device 11. In the shown embodiment, the slot 17 is disposed on an upper edge of the electronic device and is configured to slidably receive a camera frame 21 of the camera 16. In the shown embodiment, the camera 16 is removably securable to the housing 12 of the device 11 via frictional engagement or a snap-fit connection between the camera frame 21 and the slot 17. In alternate embodiments, the camera frame 21 may include one or more fasteners configured to secure the camera frame 21 within the slot 17, such as magnets or the like. In one embodiment, an outer surface 20 of the frame 21 of the first camera 16 is flush with a rear surface 18 of the rear side 13 of the housing 12 of the electronic device 11 when the first camera 16 is disposed within the slot 17, which allows the device 11 to maintain a compact configuration.

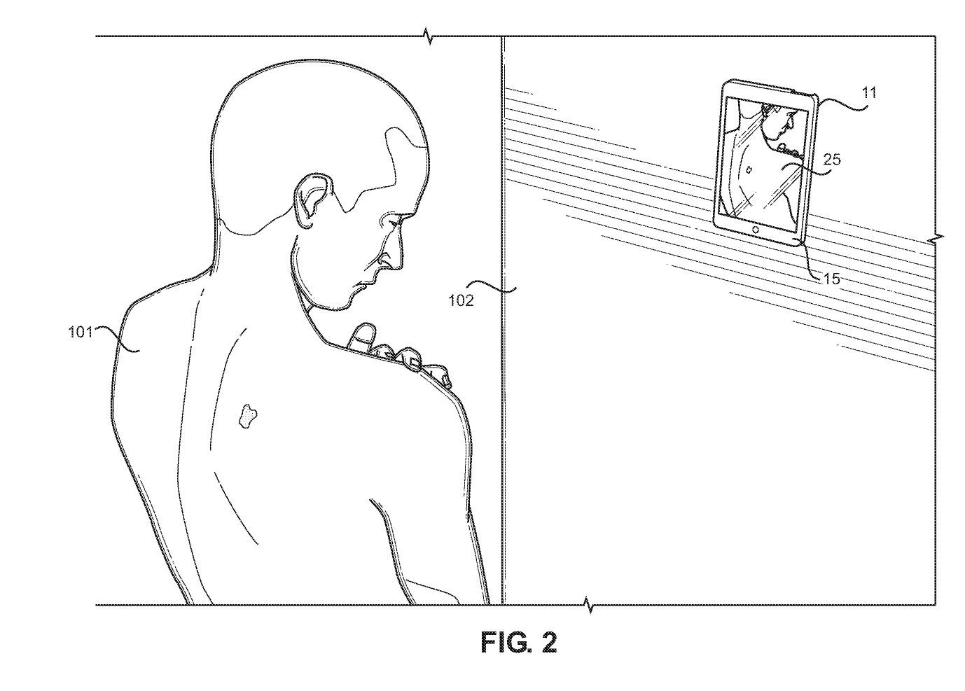

Referring now to FIGS. 2 and 3, there is shown a perspective view of the electronic mirror system in use and a side view of the electronic mirror system in use, respectively. In one operation of the electronic mirror system, the user 101 removes the first camera 16 from its slot on the electronic device 11. The user 101 then fastens the first camera 16 to a rear wall 103 situated behind the user 101 via the second mounting fastener, in order to secure the electronic device 11 to a front wall 102 situated in front of the user 101. Alternatively, the electronic device 11 can be supported on a horizontal surface or in any other manner that positions the electronic device 11 in the view of the user 101. The user 101 can then look at the display 25 on the front side 15 of the electronic device 11, which is configured to display the image captured by the first camera 16, as shown in FIG. 2. In one embodiment, the user may control the first camera 16 from the electronic device 11 utilizing touch controls or inputs which are integrated into the display 25.

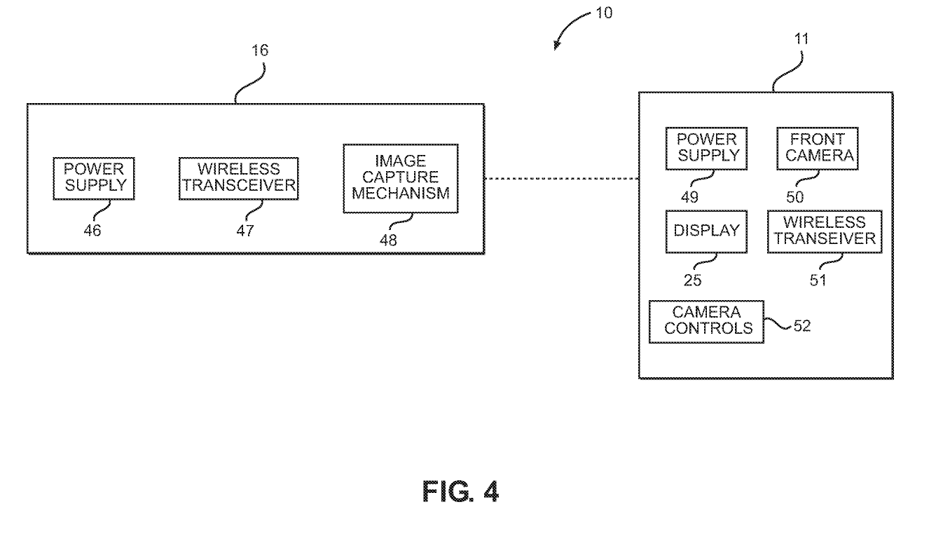

Referring now to FIG. 4, there is shown a diagram of components of the electronic mirror system. The system 10 includes the electronic device 11 and the removable camera 16. The removable first camera 16 includes a first power supply 46, a first wireless transceiver 47, and an image capture mechanism 48. The electronic device 11 includes a second power supply 49, camera controls 52, a second wireless transceiver 51, and a display 25. In one embodiment, the display 25 includes a capacitive touch screen including a plurality of inputs for operating the camera 16. The first wireless transceiver 47 is configured to transmit images captured by the image capture mechanism 48 to the electronic device 11. The second wireless transceiver 51 is configured to receive the captured images and display the images on the display 25. The first camera 16 can continuously record images for a real-time video feed, or may be configured to capture one or more individual images. In one embodiment, the electronic device 11 further includes a second front camera 50 disposed on a front side of the electronic device 11. In this way, the user may switch between the first camera 16 and the front camera 50 using the camera controls 52, such that users may alternate between viewing the front and rear side of their bodies on the display 25.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electronic mirror system, comprising:
an electronic device comprising a housing including a front side and a rear side, the housing comprising an interior volume including a first power supply and a first wireless transceiver;
a display disposed on the front side of the housing;
a first camera comprising a second power supply and a second wireless transceiver, the first camera removably securable to a slot disposed on the housing, the first camera comprising a frame including a first mounting fastener;
wherein the electronic device is in operable communication with the first camera via the first wireless transceiver and the second wireless transceiver;
wherein the first camera is configured to record images and wirelessly transmit the recorded images to the electronic device via the second wireless transceiver;
wherein the electronic device is configured to receive the recorded images;
wherein the display is configured to display the recorded images.

2) The electronic mirror system of claim 1, further comprising:
a second camera disposed on the front side of the housing, wherein the display is configured to selectively display recorded images from either the first camera or the second camera.

3) The electronic mirror system of claim 2, wherein the display comprises a capacitive touch screen including a plurality of inputs configured to control operation of the first camera and the second camera.

4) The electronic mirror system of claim 1, wherein the electronic device further comprises a second mounting fastener disposed on the rear side of the housing.

5) The electronic mirror system of claim 4, wherein the second mounting fastener comprises an adhesive material.

6) The electronic mirror system of claim 1, wherein the first mounting fastener comprises an adhesive material.

7) The electronic mirror system of claim 1, wherein the slot is disposed on an upper edge of the housing, the slot configured to slidably receive the frame of the first camera in frictional engagement therewith.

8) The electronic mirror system of claim 7, wherein a surface of the frame of the first camera is flush with a surface of the rear side of the housing when the first camera is disposed within the slot of the housing.
